(19) United States
(12) Patent Application Publication
(10) Pub. No.: US 2015/0142588 A1
(43) Pub. Date: May 21, 2015

(54) SYSTEM AND METHOD FOR MANAGEMENT OF RETAIL SITE INFRASTRUCTURE FOR MOBILE APPLICATION USAGES

(71) Applicant: SHELL OIL COMPANY, Houston, TX (US)

(72) Inventors: Peng Jong HUM, London (GB); Christopher Joseph D'SOUZA, London (GB); Athanasios KOKKINIOTIS, London (GB)

(73) Assignee: SHELL OIL COMPANY, Houston, TX (US)

(21) Appl. No.: 14/290,387

(22) Filed: May 29, 2014

Related U.S. Application Data
(60) Provisional application No. 61/828,467, filed on May 29, 2013.

(51) Int. Cl. G06Q 20/18; G06Q 50/06; G06Q 20/20

(52) U.S. Cl. CPC G06Q 20/18; G06Q 20/206; G06Q 50/06
USPC 705/18

(57) ABSTRACT

A method of authorizing a transaction at a fuel pump includes receiving a user request to activate the pump, determining whether the user is authorized, determining whether the user is in the proximity of the pump, determining whether the pump is functional, determining whether the pump is already reserved for another user, and determining whether the pump is already in use. In response to those determinations, a message is displayed, either authorizing or declining the transaction.

### RELATED CASES

This application claims the benefit of U.S. Provisional Application No. 61/828,467, filed on May 29, 2013.

### FIELD OF THE INVENTION

The invention relates to a method for management of retail site infrastructure for mobile application usages.

### BACKGROUND

In conventional fuel pumps, a human at the point of sale (POS) in the station manually controls the pumps and nozzles. Human errors lead to potential payment and fueling issues. The human manually locks and unlocks the pumps/nozzles for fueling.

### SUMMARY OF THE INVENTION

In accordance with one aspect of the present disclosure, a method of authorizing a transaction from a mobile or internet device for any mode of payment (including outdoor, indoor, etc) at a fuel pump includes receiving, from a user of an application, a request to activate the fuel pump. The method further includes determining whether that user is on a list of unauthorized users, and determining whether the user is outside a predetermined proximity of the fuel pump. The method also includes determining whether the fuel pump is non-functional, determining whether the fuel pump is already reserved for another user, and determining whether the fuel pump is already in use. The method additionally includes displaying a single or a plurality of messages regarding the authorization including other parts of the process.

In accordance with another aspect of the present disclosure, a method of reconciling a transaction from a mobile or internet device for any mode of payment (including outdoor, indoor, etc.) at a fuel pump includes receiving, from a user of an application, a request to activate the fuel pump. The method also includes determining that that user is not on a list of unauthorized users. Further, the method includes determining that the user is not outside a predetermined proximity of the fuel pump. The method additionally includes determining that the fuel pump is not non-functional. The method also includes determining that the fuel pump is not already reserved for another user and determining that the fuel pump is not already in use. Additionally, the method includes receiving, from a payment server, an indication that pre-authorisation (reserving a pre-determined amount of money) or payment is approved. The method further includes unlocking the fuel pump, and sending a message to the user verifying that fueling has commenced or to also indicate the monetary amount and/or quantity, type of fuel product or other metrics currently being dispensed. Additionally, the method includes receiving a message from the user indicating cancelation of payment for misidentification of fuel pump, and providing notification that payment is due for the transaction at the fuel pump or providing electronic and physical receipts etc.

### BRIEF DESCRIPTION OF THE FIGURES

FIG. 1 is a drawing of an orchestration process showing the Smart Timer Algorithm for “Starts Fueling at Pump” in accordance with one aspect of the present disclosure.

FIG. 2 is a drawing of an orchestration process showing the Smart Algorithm for “Stops fueling at Fuel Pump” in accordance with one aspect of the present disclosure.

FIG. 3 is a schematic diagram showing a normal usage scenario in accordance with the present disclosure.

FIG. 4 is a legend indicating three types of potential users shown in various other figures in accordance with the present disclosure.

FIG. 5 is a flow chart illustrating pump verification logic and process in accordance with the present disclosure.

FIG. 6 is a flow chart illustrating a scenario where the pump is unlocked in accordance with the present disclosure.

FIG. 7, including partial views 7-A, 7-B, and 7-C, is a flow chart illustrating a plurality of scenarios where the pump is unlocked with a wrong pump identification, where a normal user uses that wrongly identified pump to dispense fuel, and where a mobile payment user uses that wrongly identified pump to dispense fuel via the mobile application.

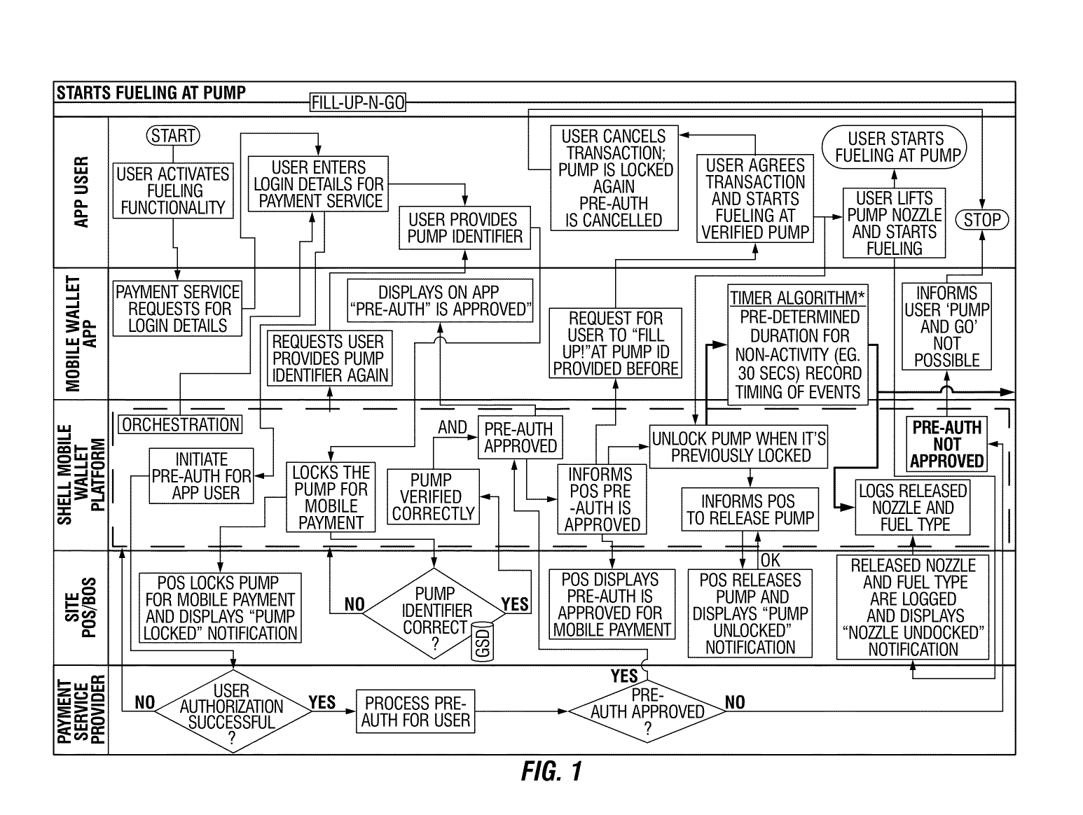

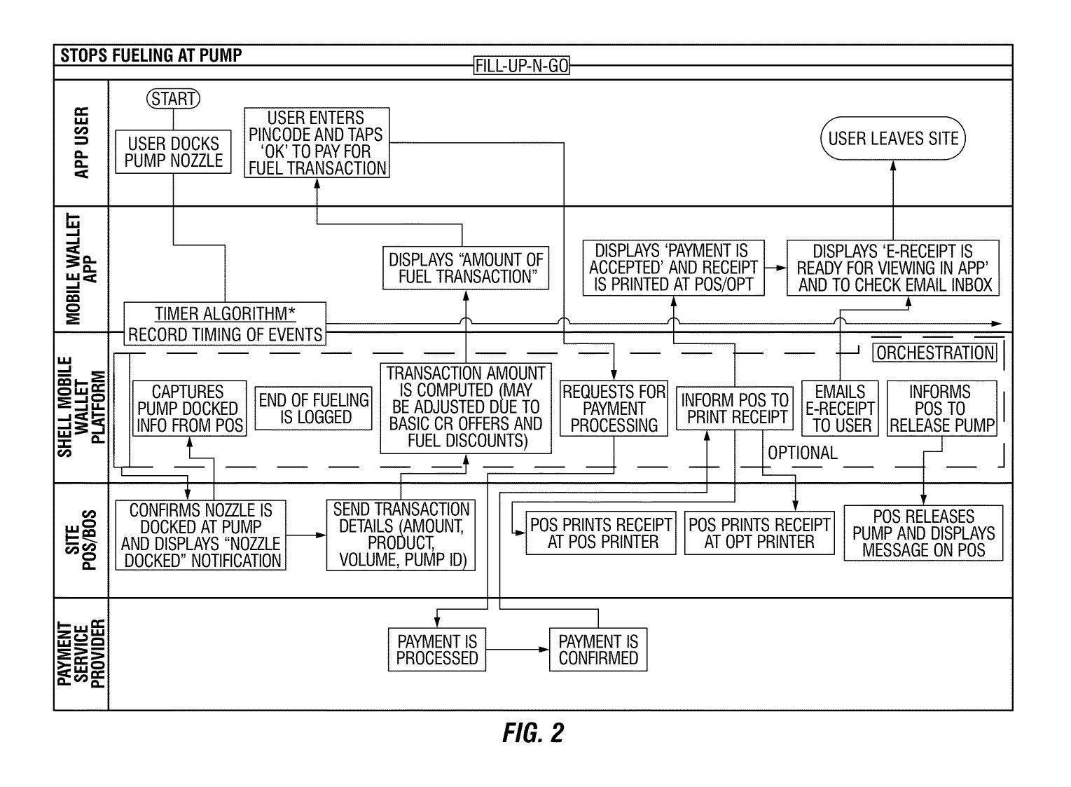

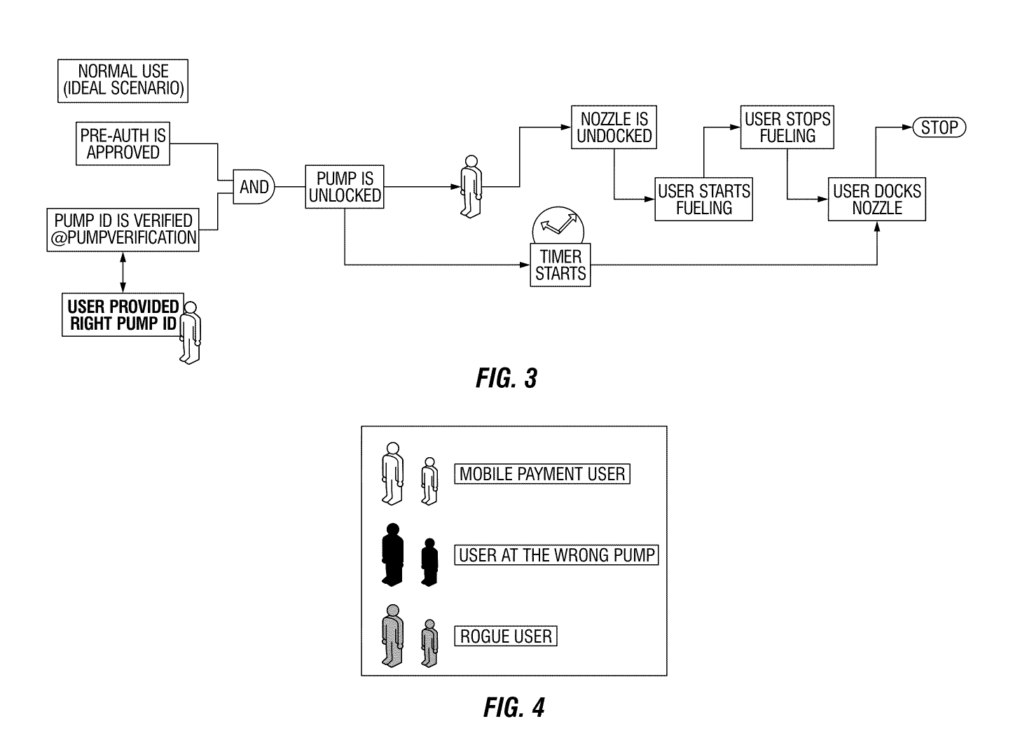

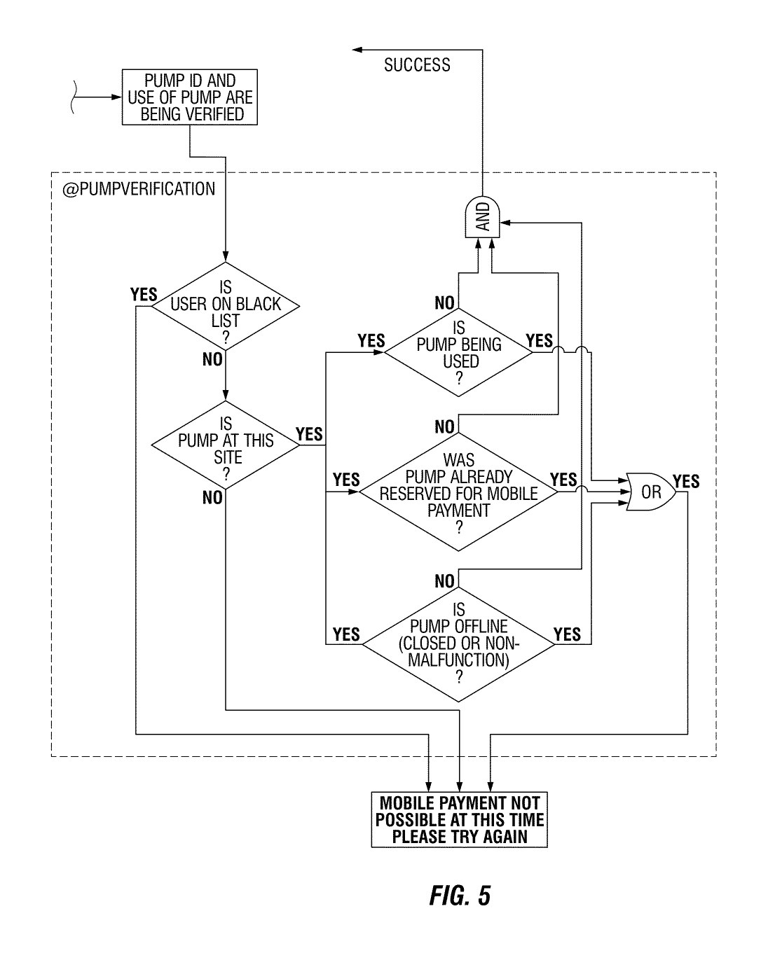

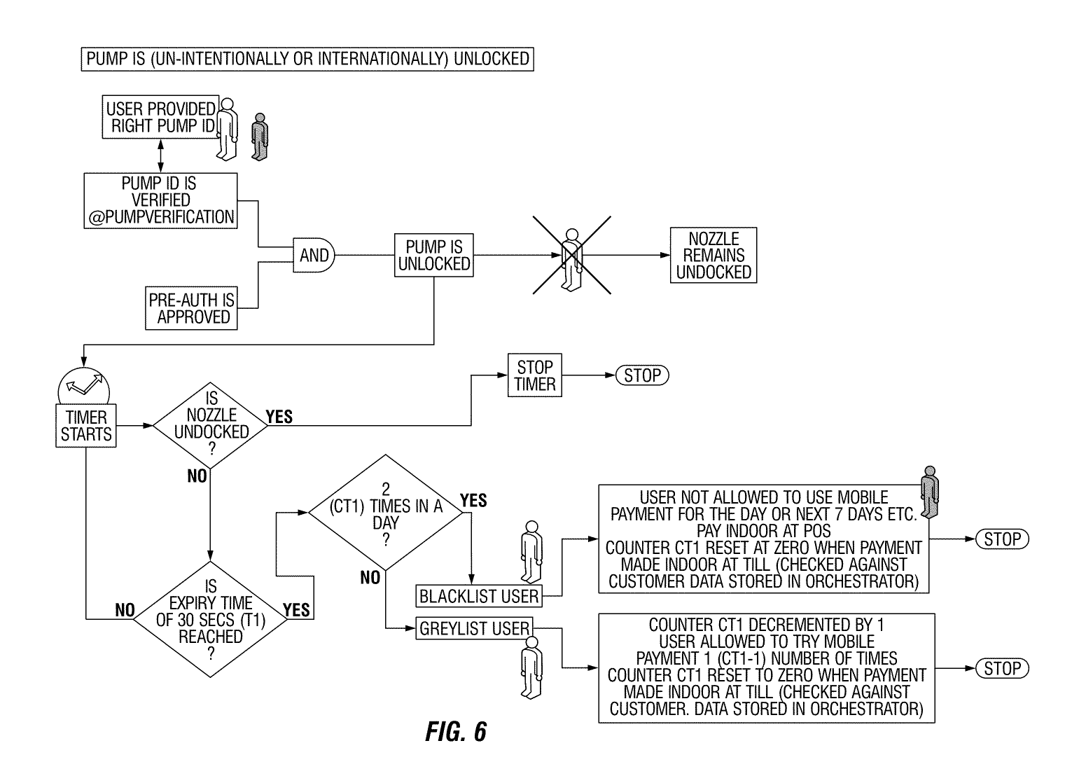

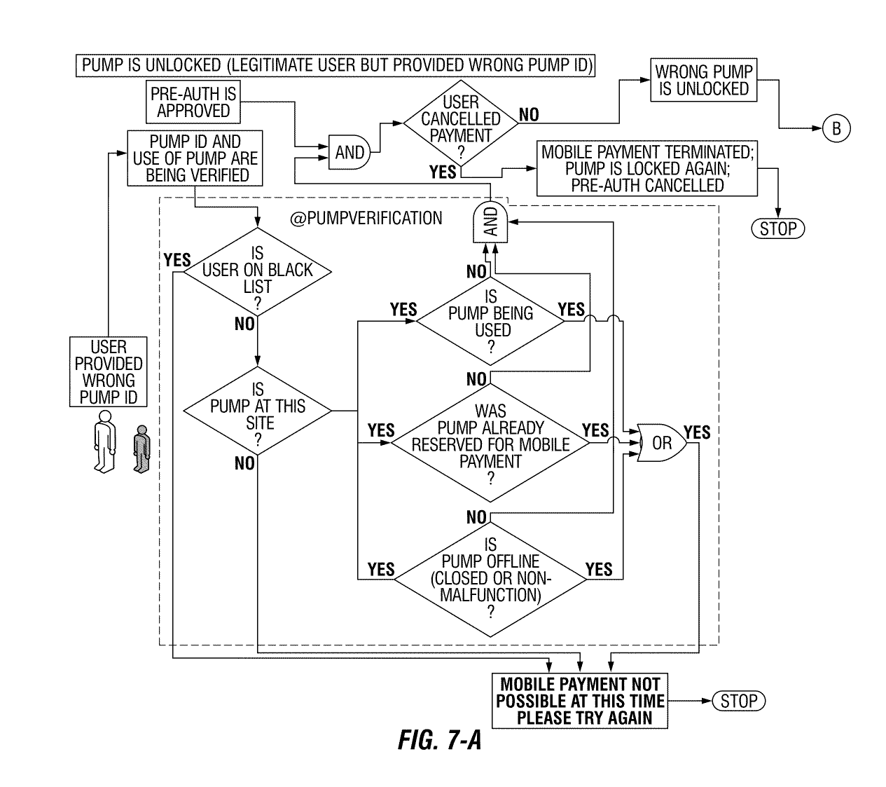

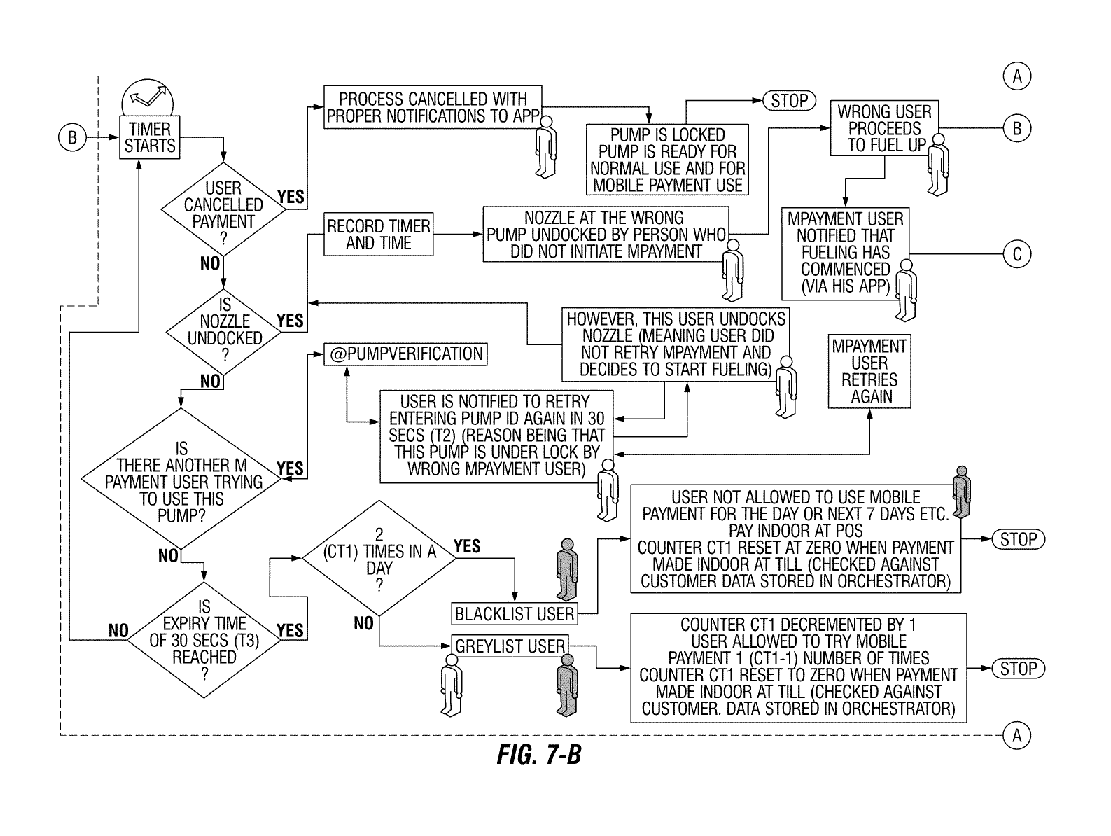

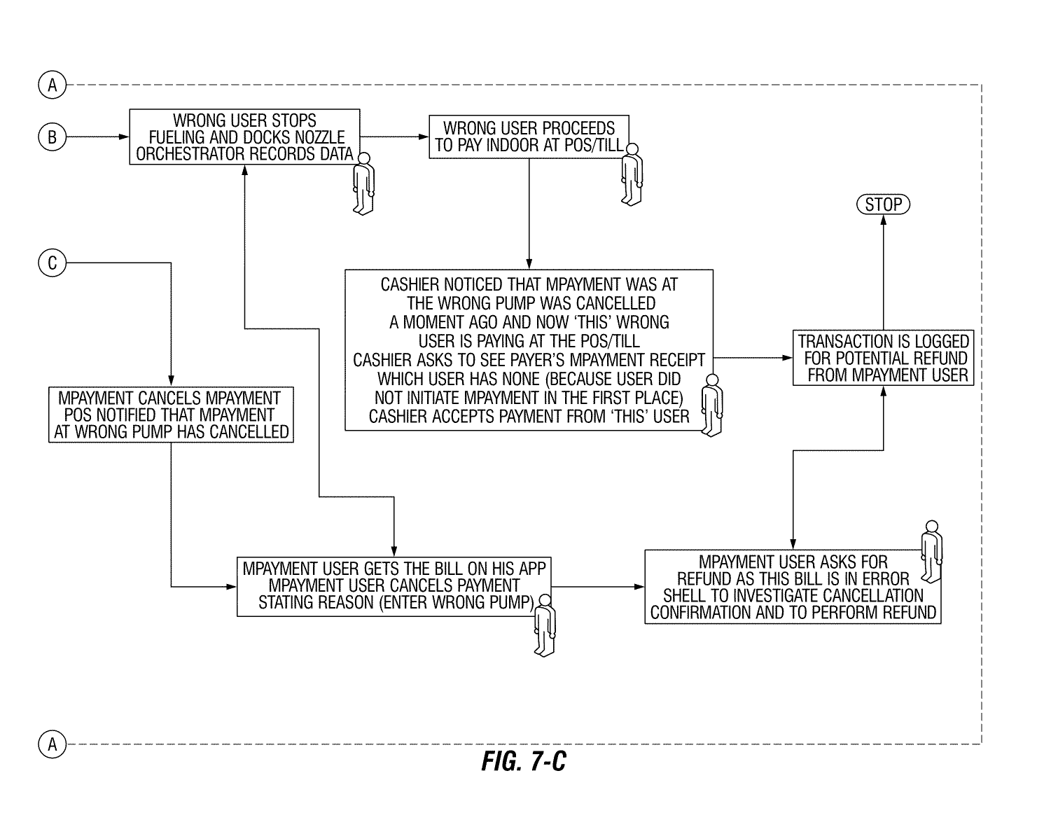

### DETAILED DESCRIPTION

In accordance with the present disclosure, an automated system may replace the error prone manual locking and unlocking of pumps/nozzles. An automated system and method can manage the safe and secure operations of any types of pumps and nozzles or other equipment at fuel stations, to provide more efficiency and effective operations and to prevent abuse of the process afforded through the convenience of the mobile payment applications on the smart devices (iPhones, Android devices, Windows, Linux, Java, BlackBerry, Symbian, all past, current and future forms of devices and device operating systems, tablets, computers, websites, watches, wearables, smart glasses, etc).

The present disclosure provides a system and method to manage, control and orchestrate the intended operations and processes (and to prevent/reduce/remove unintended forms or scenarios) of the mobile payment process through mobile apps for use at fuel stations via the monitoring and orchestrating at a middleware platform or layer of various devices and systems belonging to the retail fuel stations or any other related systems (both on-site and off-site).

Some aspects of the present disclosure thought to provide an advantage over current systems include the following:
1) The use of a smart process to monitor the timer duration in between pre-authorization of a mobile payment, the release of the identified pump/nozzle and its undocking of the nozzle and other events.
2) A set of web services and APIs (Application Programming interfaces) will support the orchestrator process and its management and control of mobile payment at the sites. Web services using HTTP/S protocols with XML or JSON payloads or other suitable protocols like SOAP, Java, IFSF, TCP/IP, iOS, Android, etc and programming methods can be used for efficient and timely communications.
3) The method provides a means to prevent the user from paying for the fuel dispensed at the wrong pump and wrong users from backing and/or hijacking' the mobile payment process. A PINCODE of arbitrary length/complexity is required to be entered on the mobile app to initiate the payment process or to authorize final payment.
4) The use of a smart Algorithm, Logic and Process Flow which includes the use of a Smart Timer with a Monitoring and Orchestrating Functionality as described here:
   1) Pump is re-locked after a Timer expires (for e.g. 30 seconds). It means that there is inactivity at the pump. This means the pump was accidentally reserved by the mobile payment user.
   2) Another scenario is that the mobile user had provided (manual entry or by other means such as Smart tags or QR code etc) the wrong pump ID or site ID or other types of identification data and had indicated the wrong pump where the user is at.
   3) Status of all pumps at the sites (and all sites) are known (data collected from POS/sites) to the Orchestrator (or a form of middleware platform for generalization purposes). Refer to Figures.
      3.1) Orchestrator provides a global and local dashboard/s to monitor the activities of all Pumps and Nozzles and other retail equipment, and the statuses of all indoor and outdoor mobile payment users at each and every site.
      3.2) Orchestrator monitors
         the activations and cancellations of all indoor and outdoor mobile payment on the mobile app,
         the confirmations of pre-authorization from the payment service providers through various payment instruments for mobile payment uses,
         the submitted pump IDs and Site IDs or any form of identification data and verifies its correctness and validity
         all the timers (start and duration, end) for all indoor and outdoor mobile payment activities and events at each and every site.
   4) The smart Algorithm will prevent any rogue mobile or web or internet user from intentionally or un-intentionally locking or releasing the pump/s while the pump/s is/are serving fuel or preventing other legitimate users from fueling or using the pumps or any other site equipment.
   5) Users who had unlocked the pump but failed to release nozzle within a pre-determined duration of say 30 seconds will be included in a blacklist or greylist. Users could be removed from a blacklist or greylist and included into a whitelist for ‘good behavior’.
      5.1) Repeated abusers three times (arbitrary number) will not be allowed for mobile payment until they pay at the POS at the station using the normal payment instruments like credit card, etc or via other methods. The Orchestrator will clear the user from the blacklist and allow the user to use mobile payment again.
5) For certain types of pumps that are fitted with keypads or any form of data entry methods, a PINCODE could be provided to the pump as a form of verification for pump release and to prevent accidental pump locking and abuse.
6) For certain types of pumps that are fitted with barcode or QR code scanners or NFC readers, an identification or verification code/s could be provided to the pump for pump release and to prevent accidental authorization, accidental pump tampering and abuse.
7) To manage and control other potential cases of abuse such as preventing any multiple concurrent requests from currently authorised users or users involved in the current process of mobile payment or fuelling

Some potential advantages of the features described herein include the following:
1) Removes possibility of remote mobile users from (intentionally or un-intentionally) or rogue users at the site from inside or outside the sites locking or releasing the pumps thereby preventing legitimate mobile users or non-mobile users at the site to use the pumps for fueling.
2) Prevent accidental (intentional or un-intentional) users from influencing the actions of pumps or other fuel station equipment and POS in an undesirable way.
3) Provides more efficient and effective management of mobile payment (including indoor and outdoor, etc) at sites.
4) Prevents and reduces human errors with an automated system that can provide efficient use of mobile payments at fuel stations to speed up a pay-and-go service at fuel stations or other similar services which involves identification of retail equipment and their actuations for all modes of mobile and non-mobile payments (including indoor, outdoor, etc).
5) Application areas of the present disclosure can be applied to buying goods in the stations and consumptions of other services at fuel stations and so on.
6) With the monitoring and orchestrating capabilities afforded in the present disclosure, the disclosure serves to prevent the occurrences of other potential abuse of using mobile payments at the Shell-owned and Shell-operated fuel stations or retail stores or any other forms of Shell sites.
7) The use of other methods like NFC or contactless Smart-tags or QR codes or other forms of pump/site/equipment etc identifications could be included in the method
8) The use of other methods of pump/site/equipment etc identifications like manual entry, QR code scanning, NFC RFID tags, voice entry, or any other methods can be included within this method.
9) This method does not exclude the possible use of the other devices or methods related to the mobile app or other current and future functionalities of fuel or retail equipment or services.
10) The Orchestrator could be linked to other systems that offer other services like fuel discounts, loyalty, offers, ticketing, vouchers, any form of redemptions, fuel discounts, convenience retail goods, and so on.
11) Prevents the mobile payment user from mis-identifying the pump a pre-determined number of times
12) To manage and control other potential cases of abuse such as preventing any multiple concurrent requests from currently authorised users or users involved in the current process of mobile payment or fuelling

The aspects described in this disclosure contribute to a solution allowing for freedom and ability to offer safe and secure mobile payment experience at all fuel and retail stations via mobile applications usages.

Those of skill in the art will appreciate that many modifications and variations are possible in terms of the disclosed embodiments, configurations, materials, and methods without departing from their scope. Accordingly, the scope of the claims and their functional equivalents should not be limited by the particular embodiments described and illustrated, as these are merely exemplary in nature and elements described separately may be optionally combined.

What is claimed is:

1. A method of authorizing a transaction at a fuel pump, comprising:
receiving, from a user of an application, a request to activate the fuel pump;
determining whether that user is on a list of unauthorized users;
determining whether the user is outside a predetermined proximity of the fuel pump (determined by GPS, Geofencing, contactless or other suitable methods);
determining whether the fuel pump is non-functional;
determining whether the fuel pump is already reserved for another user;
determining whether the fuel pump is already in use; and
displaying a message regarding the authorization or a plurality of messages regarding any parts of the process or receipts of any forms (electronic, physical, etc).

2. The method of claim 1, wherein the message comprises an approval message responsive to all determination steps being negative.

3. The method of claim 1, wherein in the message comprises a denial message responsive to at least one determination steps being positive.

4. The method of claim 2, further comprising:
receiving, from a payment server, an indication that payment is approved;
unlocking the fuel pump;
after unlocking the fuel pump, determining whether a nozzle of the fuel pump has been undocked, determining whether an expiry time has been reached; and
stopping the timer.

5. The method of claim 4, wherein responsive to a determination that the nozzle has been undocked, the step of stopping the timer occurs immediately.

6. The method of claim 4, wherein responsive to a determination that an expiry time has been reached, the method further comprises determining whether the user is associated with excessive use.

7. The method of claim 6, wherein determining whether the user is associated with excessive use comprises determining whether the user has initiated transactions more than a first threshold number of times in a particular time frame; and wherein the method comprises placing the user on the list of unauthorized users.

8. A method of reconciling a transaction at a fuel pump, comprising:
receiving, from a user of an application, a request to activate the fuel pump;
determining that that user is not on a list of unauthorized users;
determining that the user is not outside a predetermined proximity (determined via GPS, Geofencing, contactless or any other methods) of the fuel pump;
determining that the fuel pump is not non-functional;
determining that the fuel pump is not already reserved for another user;
determining that the fuel pump is not already in use; receiving, from a payment server, an indication that payment is approved;
unlocking and locking the fuel pump;
sending a message to the user verifying that fueling has commenced;
receiving a message from the user indicating cancelation of payment for misidentification of fuel pump; and
providing notification that payment is due for the transaction at the fuel pump.
providing electronic or physical receipts to confirm payment details.
